(19) United States
(12) Patent Application Publication
(10) Pub. No.: US 2026/0328350 A1
(43) Pub. Date: Oct. 22, 2026

(54) FIXTURE AND METHOD FOR MOUNTING LIGHT PANELS

(71) Applicant: HARMAN INTERNATIONAL INDUSTRIES, INCORPORATED, Stamford, CT (US)

(72) Inventors: Qiang WANG, Shenzhen (CN); Yuling ZHENG, Shenzhen (CN); Shuangju WEI, Shenzhen (CN)

(21) Appl. No.: 19/122,963

(22) PCT Filed: Dec. 16, 2022
(86) PCT No.: PCT/CN2022/139603

§ 371 Date: Apr. 21, 2025

(51) Int. Cl. F21S 2/00; F21S 8/00; F21V 21/005; F21V 21/02

(52) U.S. Cl. CPC F21S 2/005; F21S 8/033; F21V 21/02

(57) ABSTRACT

A fixture (100) and a method for mounting a plurality of light panels onto a surface is provided. The plurality of light panels have multiple different polygonal shapes that may be assembled to form an assembled light panel having a larger area, each of the plurality of light panels having a light panel body of a polygonal shape and a mounting plate detachably connected to the light panel body. The fixture (100) comprises one or more aligning sides (142, 146, 148) and a plurality of openings (112, 122, 132), each opening is sized and shaped to receive a respective mounting plate of a light panel therein, the position of each opening in relation to at least one aligning side of the fixture is the same as or corresponds to the position of the respective mounting plate in relation to at least one side of the light plate to which it is connected.

### TECHNICAL FIELD

This disclosure relates in general to a fixture and a method for mounting light panels.

### BACKGROUND

Recently, wall lighting products consisting of multiple light panels with different shapes are becoming more and more popular because a user can freely assemble the multiple light panels onto a wall to form a lighting product with a desirable shape with a larger area according to his own preference. When the user mounts the light panels one by one onto the wall, he or she needs a way to locate or align new light panels relative to existing light panels on the wall. Currently, such locating or aligning of new light panels with respect to existing ones basically relies on the light panels themselves. That is, the users align the new light panel with an existing light panel on the wall and meanwhile attach the new light panel to the wall. This mounting method usually uses adhesive to attach the light panels to the wall and it may be difficult to use fasteners such as screws to mount light panels, which may be desirable because it can provide a more secure attachment. Meanwhile, the mounting method may not be easy because the locating or aligning of the new panel must be done together with the attachment of the light panel to the wall. Therefore, there is a need for a mounting fixture or method that can mount the light panels easily and securely and/or can use fasteners such as screws.

### SUMMARY OF THE INVENTION

According to one aspect of the disclosure, a fixture for mounting a plurality of light panels onto a surface is provided. The plurality of light panels having multiple different polygonal shapes that may be assembled to form an assembled light panel having a larger area, each of the plurality of light panels having a light panel body of a polygonal shape and a mounting plate detachably connected to the light panel body. The fixture comprises one or more aligning sides and a plurality of openings, each opening is sized and shaped to receive a respective mounting plate of a light panel therein, the position of each opening in relation to at least one aligning side of the fixture is the same as or corresponds to the position of the respective mounting plate in relation to at least one side of the light plate to which it is connected.

According to another aspect of the disclosure, a method of mounting a plurality of light panels onto a surface by using the fixture is provided. The method comprises the steps of: locating the fixture with respect to an existing light panel that is already mounted to the surface; locating or matching a mounting plate of a new light panel into an opening of the fixture and attaching the mounting plate to the surface; removing the fixture from the existing light panel; attaching a light panel body of the new light panel to the mounting plate.

Others systems, method, features and advantages of the disclosure will be, or will become, apparent to one with skill in the art upon examination of the following figures and detailed description. It is intended that all such additional systems, methods, features and advantages be included within this description, be within the scope of the disclosure, and be protected by the following claims.

### BRIEF DESCRIPTION OF THE DRAWINGS

The present disclosure can be better understood with reference to the following drawings and description. The components in the drawings are not necessarily to scale, instead, emphasis should be placed upon the principles illustrated by the disclosure. Moreover, in the figures, like reference numerals designate like parts throughout the drawings.

FIG. 1 is a schematic diagram showing a fixture for mounting light panels according to one or more embodiments of the present disclosure;

FIGS. 2A-2F are schematic diagrams showing light panels according to one or more embodiments of the present disclosure, wherein FIGS. 2A-2B show a light panel having a hexagon shape, FIGS. 2C-2D show a light panel having a diamond shape and FIGS. 2E-2F show a light panel having a triangular shape;

FIGS. 3A-3F show a process of mounting a light panel having a hexagon shape to an existing light panel by using a fixture according to one or more embodiments of the present disclosure;

FIGS. 4A-4H show a process of mounting a light panel having a diamond shape to an existing light panel by using a fixture according to one or more embodiments of the present disclosure; and FIGS. 5A-5F show a process of mounting a light panel having a triangular shape to an existing light panel by using a fixture according to one or more embodiments of the present disclosure.

### BRIEF DESCRIPTION OF THE PREFERRED EMBODIMENTS

Hereinafter, several embodiments of the present disclosure will be described in more detail with reference to the accompanying drawings.

As used herein, the singular forms “a”, “an” and “the” are intended to include the plural forms as well, unless the context clearly indicates otherwise. The terms “comprises”, “comprising”, “includes” and/or “including”, as used herein, specify the presence of stated features, integers, steps, operations, elements, and/or components, but do not preclude the presence or addition of one or more other features, integers, steps, operations, elements, components, and/or combinations thereof. As used herein, the term “and/or” and the symbol “/” are meant to include any and all combinations of one or more of the associated listed items. Additionally, while the terms first, second etc. may be used herein to describe various elements, components, steps or calculations, these elements, components, steps or calculations should not be limited by these terms, rather these terms are only used to distinguish one element, component, step or calculation from another. For example, a first component could be termed a second component, similarly a first calculation could be termed a second calculation; similarly a first step could be termed a second step; all without departing from the scope of this disclosure.

To clarify the use in the pending claims and to hereby provide notice to the public, the phrases “at least one of <A>, <B>, . . . and <N>” or “at least one of <A>, <B>, . . . <N>, or combinations thereof” are defined by the Applicant in the broadest sense, superseding any other implied definitions herebefore or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

The disclosure provides a fixture and a method for mounting a plurality of light panels onto a surface. The fixture comprises one or more aligning sides and a plurality of openings each sized and shaped to receive a respective mounting plate of a light panel therein, the position of each opening in relation to at least one aligning side of the fixture is the same as or corresponds to the position of the respective mounting plate in relation to at least one side of the light plate to which it is connected. Thus, the fixture can be used to properly locate a mounting plate of a new light plate with respect to an existing light panel that is already mounted on the surface. Moreover, the plurality of openings in the fixture enable properly locating mounting plates of light panels of different shapes with respect to an existing light panel by a single fixture.

In one or more embodiments of the present disclosure, the openings on the fixture are through openings. By using the through opening, the mounting plate can be easily and securely attached to the surface, such as a wall. In some embodiments, the mounting plate may be attached to the surface by a fastener, such as a screw.

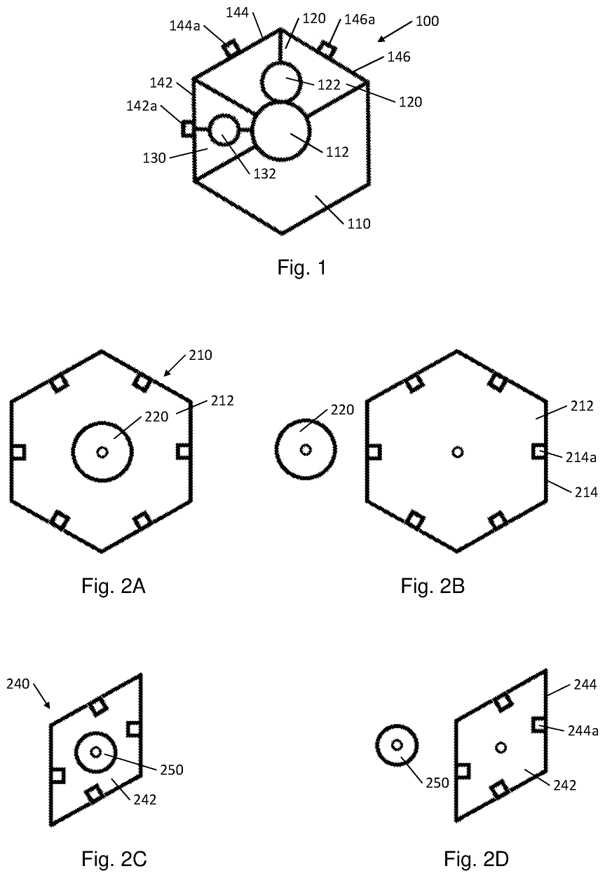

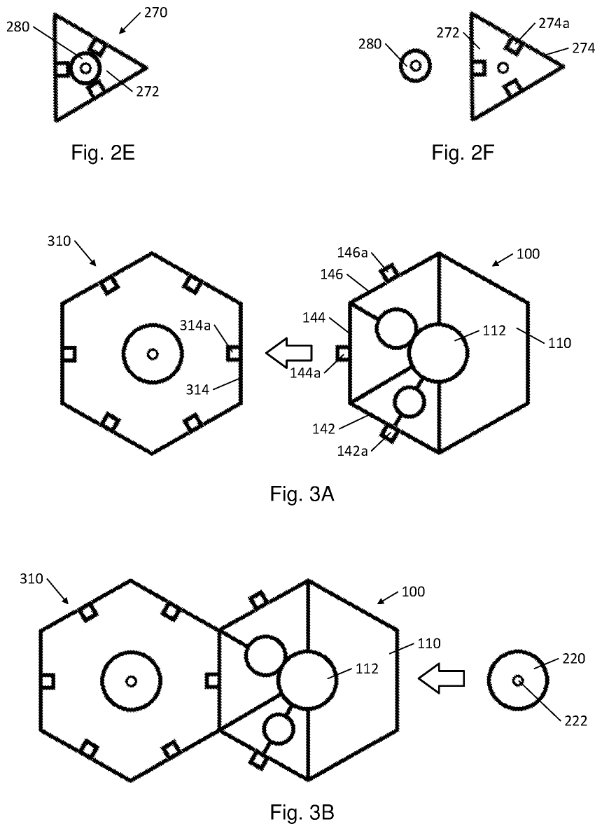

FIG. 1 is a schematic diagram showing a fixture 100 for mounting light panels according to one or more embodiments of the present disclosure. FIGS. 2A-2F are schematic diagrams showing light panels according to one or more embodiments of the present disclosure, wherein there are three different shapes of light panels, i.e., the light panel 210, the light panel 240 and the light panel 270.

The light panel 210 is shown in FIGS. 2A-2B, wherein FIG. 2A is an assembled view of the light panel 210 and the FIG. 2B is an exploded view of the light panel 210. The light panel 210 comprises a light panel body 212 of a hexagon shape and a mounting plate 220 of a circular shape. As shown, when assembled, the mounting plate 220 is centered relative to the light panel body 212. The light panel body 212 has six sides 214, each of which has a substantially same length, with an angle of 120 degrees being formed between each two adjacent sides 214. The light panel body 212 also has six slots 214a, each of which is formed in one of the sides 214.

The light panel 240 is shown in FIGS. 2C-2D, wherein FIG. 2C is an assembled view of the light panel 240 and the FIG. 2D is an exploded view of the light panel 240. The light panel 240 comprises a light panel body 242 of a diamond shape and a mounting plate 250 of a circular shape. As shown, when assembled, the mounting plate 250 is centered relative to the light panel body 242. The light panel body 242 has four sides 244, each of which has a substantially same length, with an angle of 60 or 120 degrees being formed between two adjacent sides 244. The light panel 242 also has four slots 244a, each of which is formed in one of the sides 244.

The light panel 270 is shown in FIGS. 2E-2F, wherein FIG. 2E is an assembled view of the light panel 270 and the FIG. 2F is an exploded view of the light panel 270. The light panel 270 comprises a light panel body 272 of a triangular shape and a mounting plate 280 of a circular shape. As shown, when assembled, the mounting plate 280 is centered relative to the light panel body 272. The light panel body 272 has three sides 274 each of which has a substantially same length, with an angle of 60 degrees being formed between two adjacent sides 274. The light panel 272 also has three slots 274a, each of which is formed in one of the sides 274.

In the embodiments shown in FIGS. 2A-2F, the side length of the light panel body 212 is the same as those of the light panel body 242 and/or the light panel body 272. As appreciated, with the sizes and shapes of the light panels 210, 240 and 270, a user can freely assemble them onto a wall to form an assembled light panel having a desirable shape with a larger area according to his own preference.

As shown in FIG. 1, the fixture 100 has a fixture body 110, which has a same or similar size or shape of the light panel body 212. That is, the fixture body 110 is of a hexagon shape having six sides, each of which has a substantially same length as the sides 214 of the light panel body 212, with an angle of 120 degrees being formed between each two adjacent sides. The fixture body 110 also comprises a center opening 112 which is sized and shaped to accommodate a mounting plate 220.

The fixture body 110 also comprises a diamond portion 120 and a triangular portion 130, each of which is a portion of the hexagon shape of the fixture body 110. The diamond portion 120 is of a diamond shape, which shares two sides, i.e., sides 144, 146, with the hexagon shape of the fixture body 110. That is, the sides 144 and 146 are two sides of the hexagon shape of the fixture body 110, and they are also two sides of the diamond shape of the diamond portion 120. The diamond portion 120 also comprises a center opening 122 which is sized and shaped to accommodate a mounting plate 250. The triangular portion 130 is of a triangular shape, which shares one sides, i.e., the side 142, with the hexagon shape of the fixture body 110. That is, the side 142 is one side of the hexagon shape of the fixture body 110, and it is also one side of the diamond shape of the triangular portion 130. The triangular portion 130 also comprises a center opening 132 which is sized and shaped to accommodate a mounting plate 280. The fixture body 110 also comprises three projections 142a, 144a and 146a, each of which is provided on one of the sides 142, 144 and 146. Each of the projections 142a, 144a and 146a is sized and shaped to be received in one of the slots 214a, 244a, 274a of the light panel bodies 212, 242 and 272. The sides 142, 144 and 146 and corresponding projections 142a, 144a and 146a of the fixture body 110 may function to locate and align the fixture body 110 relative to an existing light panel, and the sides 142, 144 and 146 and corresponding projections 142a, 144a and 146a may be referred to as a first aligning side 142, a second aligning side 144 and a third aligning side 146 as well as a first projection 142a, a second projection 144a and a third projection 146a.

In the embodiments shown in FIGS. 1 and 2A-2F, the fixture 100 has a substantially same shape as the light panel 210, and the position of the opening 112 in the fixture 110 is the same as the position of the mounting plate 220 in the light panel body 212. Similarly, the diamond portion 120 has a substantially same shape as the light panel 240, and the position of the opening 122 in the diamond portion 120 is the same as the position of the mounting plate 250 in the light panel body 242. The triangular portion 130 has a substantially same shape as the light panel 270, and the position of the opening 132 in the triangular portion 130 is the same as the position of the mounting plate 280 in the light panel body 272. In some other embodiments, the fixture may not have a complete hexagon shape. The fixture can still work properly as long as the positions of openings 112, 122, 132 in relation to the sides 142, 144, 146 of the fixture are the same as or correspond to the position of the respective mounting plates 220, 250, 280 in relation to the sides of the light plates 210, 240, 270.

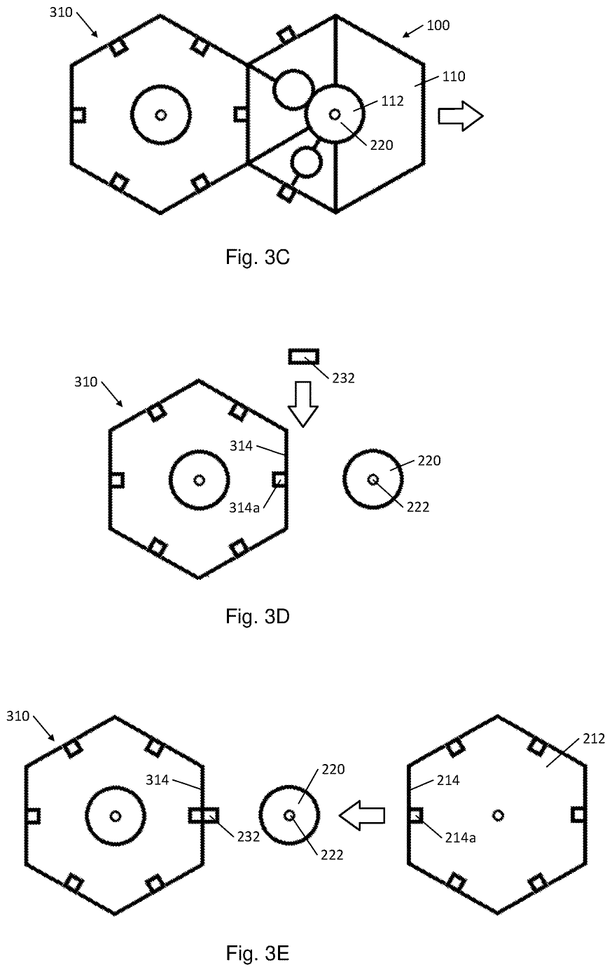

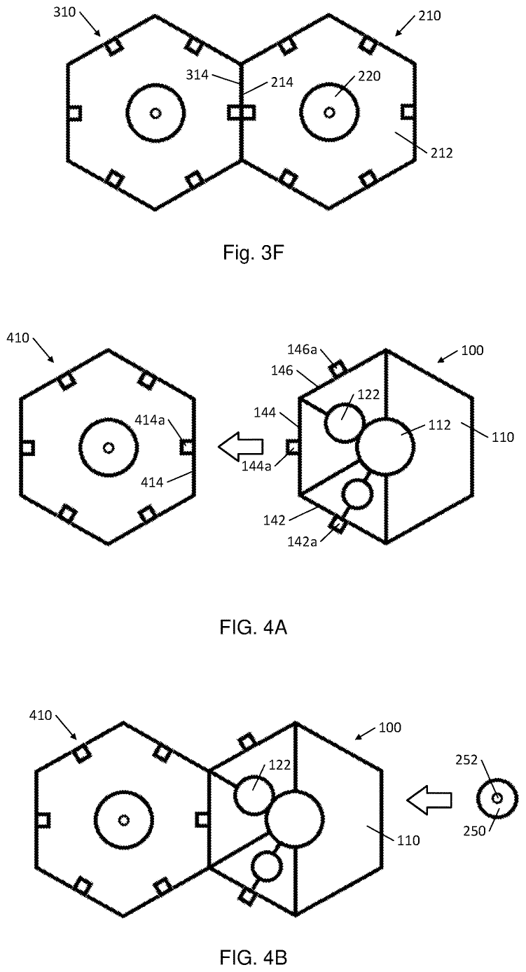

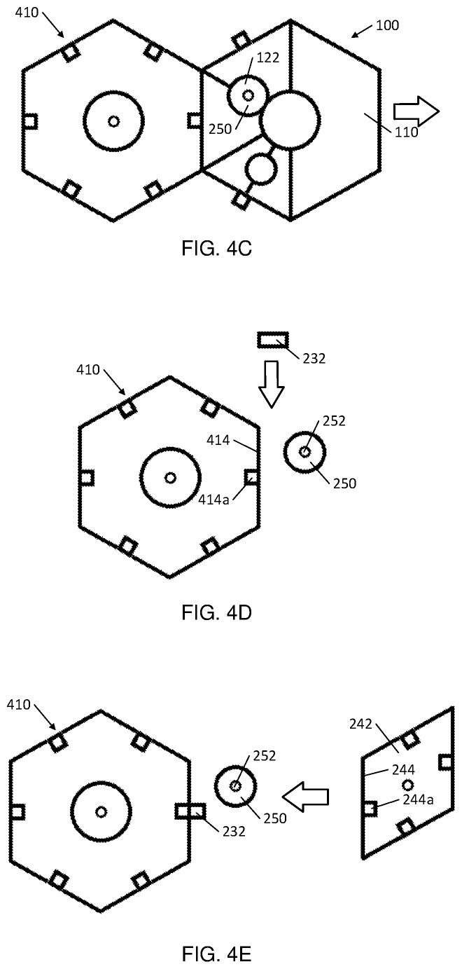

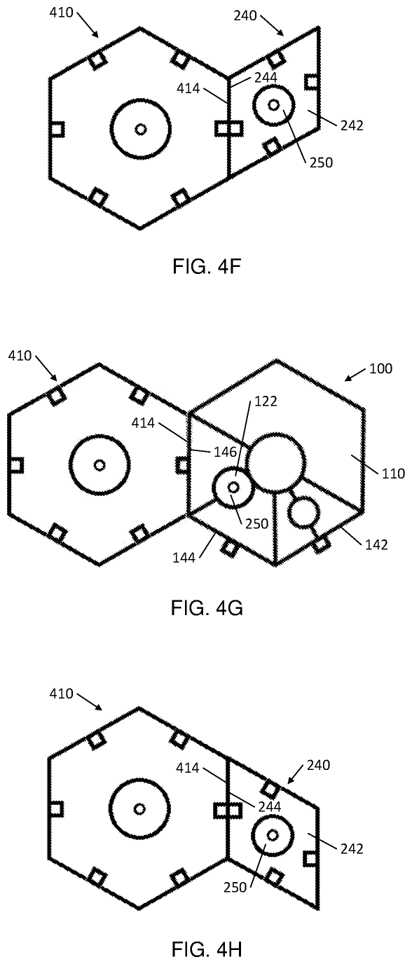

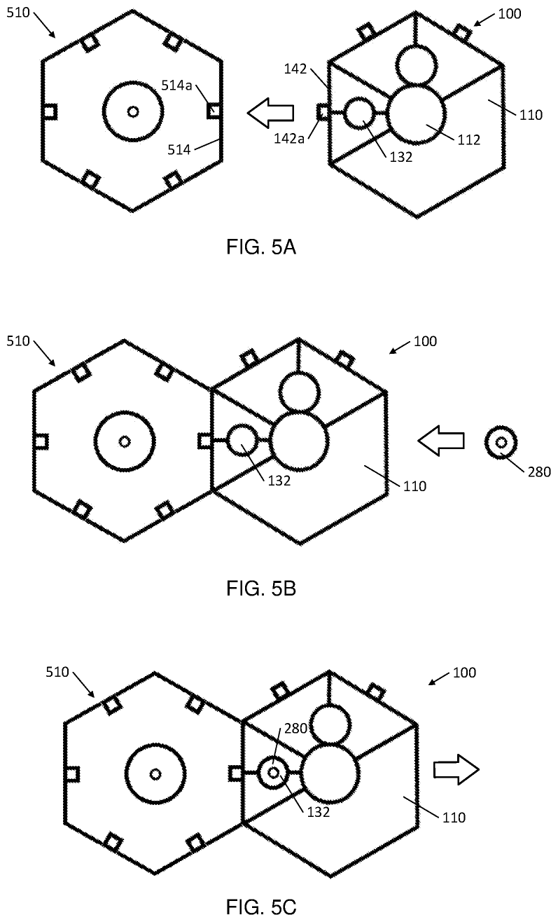

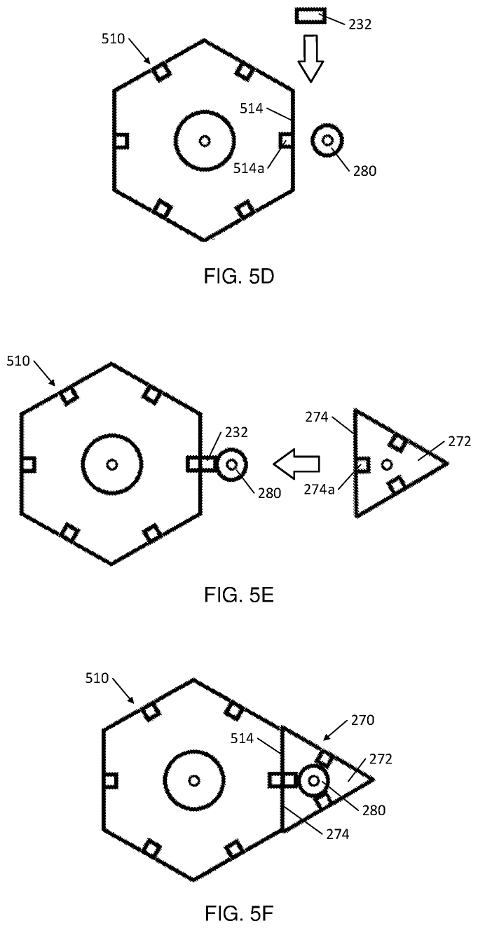

FIGS. 3A-3F show a process of mounting a light panel 210 to an existing light panel 310 by using a fixture 100 according to one or more embodiments of the present disclosure. FIGS. 4A-4H show a process of mounting a light panel 240 to an existing light panel 410 by using a fixture 100 according to one or more embodiments of the present disclosure. FIGS. 5A-5F show a process of mounting a light panel 270 to an existing light panel 510 by using a fixture 100 according to one or more embodiments of the present disclosure. In some embodiments of the present disclosure, the existing light panel 310, 410, 510 may be a light panel already mounted to a wall and the light panel 210, 240, 270 may be a new light panel to be mounted to the wall in relation to the existing light panel 310, 410, 510. In some other embodiments of the present disclosure, the existing light panel 310, 410, 510 and the light panel 210, 240, 270 may be mounted to any suitable surface. In the embodiments shown in FIGS. 3A-3F, FIGS. 4A-4H and FIGS. 5A-5F, the light panel 210, 240, 270 is mounted in relation to one existing light panel having a hexagon shape. The present disclosure is not limited thereto, and there may be any suitable number of existing light panels that are already mounted on a wall before the light panel 210, 240, 270, the existing light panel may have any suitable shape, such as a light panel having a hexagon shape, a light panel having a diamond shape or a light panel having a triangular shape.

The process of mounting a light panel 210 of a hexagon shape to an existing light panel 310 by using a fixture 100 will be described hereinafter by reference to FIGS. 3A-3F. The process comprises a step of locating a fixture 100 with respect to an existing light panel 310 that is already mounted to a wall or a surface, as shown in FIG. 3A. The step of locating the fixture 100 comprises aligning one of the aligning sides 142, 144 and 146 of the fixture 100 with a side 314 of the existing light panel 310, and inserting a corresponding projection 142a, 144a, 146a into the slot 314a. After the fixture 100 is properly located or aligned with respect to the existing light panel 310, the center opening 112 (hereinafter may be referred to as a first opening) of the fixture body 110 is also properly located with respect to the existing light panel 310.

The process further comprises a step of locating or matching the mounting plate 220 of a light panel 210 into the first opening 112 of the fixture 100, as shown in FIG. 3B. The first opening 112 of the fixture 100 is sized or shaped to receive the mounting plate 220 of the light panel 210, so that once the mounting plate 220 is located or received in the first opening 112, the mounting plate is properly located or positioned with respect to the fixture 100, and thus is also properly located or positioned with respect to the light panel 310. The process further comprises a step of attaching the mounting plate 220 to the wall or surface by adhesive or a fastener (not shown). In one or more embodiments, the fastener may be a screw and/or the mounting plate 220 may be secured to the wall by the fastener or screw extending through a center hole 222 of the mounting plate 220. In one or more embodiments of the present disclosure, the first opening 112 is a through opening, and thus the mounting plate 220 can be located in the first opening 112 and then attached to the wall or surface easily and securely, either by adhesive or a fastener. In some circumstances, it is favorable to attach the mounting plate by using a fastener, such as a screw, as such a fastener may achieve a very secure attachment of the mounting plate 220 to the wall or surface.

The process further comprises a step of removing or detaching the fixture 100 from the light panel 310 and the mounting plate 220, as shown in FIG. 3C. Since the mounting plate 220 is already securely attached to the wall or surface, the mounting plate 220 is properly located or positioned with respect to the light panel 310 after the fixture 100 is removed or detached from the light panel 310.

The process further comprises a step of locating or mounting a bridge piece 232 into a slot 314a of the light panel 310, as shown in FIG. 3D. The process further comprises a step of mounting or attaching the light panel body 212 to the mounting plate 220, as shown in FIG. 3E. The step of mounting or attaching the light panel body 212 to the mounting plate 220 also comprises receiving the bridge piece 232 in the slot 214a of the light panel 210. The light panel body 212 may be attached to the mounting plate 220 by any suitable means, such as a snap connection. Since the mounting plate 220 is already properly located or positioned with respect to the light panel 310, once the light panel body 212 is mounted or attached to the mounting plate 220, the light panel body 212 can be located or positioned properly with respect to the existing light panel 310. Particularly, as discussed before, the position of the opening 112 in relation to the aligning sides 142, 144 and 146 of the fixture 100 is the same as the position of the mounting plate 220 in relation to the sides of the light plate 210. Thus, the side 214 of the light panel body 212 can be properly aligned with the side 314 of the existing light panel 310, as shown in FIG. 3F.

The process of mounting a light panel 240 of a diamond shape to an existing light panel 410 by using a fixture 100 will be described hereinafter by reference to FIGS. 4A-4H. The process comprises a step of locating a fixture 100 with respect to an existing light panel 410 that is already mounted to a wall or a surface, as shown in FIG. 4A. The step shown in FIG. 4A is similar to the step shown in FIG. 3A, except that in FIG. 4A, a specific aligning side, i.e., aligning side 144 is aligned with a side 414 of the existing light panel 410, and a specific projection, i.e., the projection 144a formed on the aligning side 144 is received in the slot 414a. Once the fixture 100 is properly located or aligned with respect to the existing light panel 410, the opening 122 (hereinafter may be referred to as a second opening) of the fixture body 110 can also be properly located or aligned with respect to the existing light panel 410.

The process further comprises a step of locating or matching the mounting plate 250 of a light panel 240 into the second opening 122 of the fixture 100, as shown in FIG. 4B. The second opening 122 of the fixture 100 is sized or shaped to receive the mounting plate 250 of the light panel 240, so that once the mounting plate 250 is located or received in the second opening 122, the mounting plate is properly located or positioned with respect to the fixture 100, and thus it is also properly located or positioned with respect to the light panel 410.

The process further comprises a step of removing or detaching the fixture 100 from the light panel 410 and the mounting plate 250, as shown in FIG. 4C. Since the mounting plate 250 is already securely attached to the wall or surface, the mounting plate 250 is properly located or positioned with respect to the light panel 410 after the fixture 100 is removed or detached from the light panel 410.

The process further comprises a step of locating or mounting a bridge piece 232 into slot 414a of the light panel 410, as shown in FIG. 4D. The process further comprises a step of mounting or attaching the light panel body 242 to the mounting plate 250, as shown in FIG. 4E. The step of mounting or attaching the light panel body 242 to the mounting plate 250 also comprises receiving the bridge piece 232 in the slot 244a of the light panel 240. As discussed before, the position of the opening 122 in relation to the aligning sides 144 and 146 of the fixture 100 is the same as the position of the mounting plate 250 in relation to the sides of the light plate 250. Thus, the side 244 of the light panel body 242 can be properly aligned with the side 414 of the existing light panel 410, as shown in FIG. 4F. The process shown in FIGS. 4A-4F may be similar to the process shown in FIGS. 3A-3F, and detailed description thereof may be omitted.

FIGS. 4G-4H show a process of attaching a light panel 240 to the existing light panel 410 in another orientation. The process shown in FIGS. 4G-4H may be similar to the process shown in FIGS. 4A-4F except that in the step shown in FIG. 4A, the aligning side 144 is aligned with a side 414 of the existing light panel 410 and the projection 144a formed on the aligning side 144 is received in the slot 414a, while in the step shown in FIG. 4G, the aligning side 146 is aligned with a side 414 of the existing light panel 410 and the projection 146a formed on the aligning side 146 is received in the slot 414a. As shown in FIG. 4H, the light panel 240 attached to the existing light panel 410 is in a different orientation from that shown in FIG. 4F.

The process of mounting a light panel 270 of a triangular shape to an existing light panel 510 by using a fixture 100 will be described hereinafter by reference to FIGS. 5A-5F. The process comprises a step of locating a fixture 100 with respect to an existing light panel 510 that is already mounted to a wall or a surface, as shown in FIG. 5A. The step shown in FIG. 5A is similar to the step shown in FIG. 3A, except that in FIG. 5A, a specific aligning side, i.e., aligning side 142 is aligned with a side 514 of the existing light panel 510, and a specific projection, i.e., the projection 142a formed on the aligning side 142 is received in the slot 514a. Once the fixture 100 is properly located or aligned with respect to the existing light panel 510, the opening 132 (hereinafter may be referred to as a third opening) of the fixture body 110 can also be properly located or positioned with respect to the existing light panel 510.

The process further comprises a step of locating or matching the mounting plate 280 of a light panel 270 into the third opening 132 of the fixture 100, as shown in FIG. 5B. The third opening 132 of the fixture 100 is sized or shaped to receive the mounting plate 280 of the light panel 270, so that once the mounting plate 280 is located or received in the third opening 132, the mounting plate is properly located or positioned with respect to the fixture 100, and thus it is also properly located or positioned with respect to the light panel 510.

The process further comprises a step of removing or detaching the fixture 100 from the light panel 510 and the mounting plate 280, as shown in FIG. 5C. Since the mounting plate 280 is already securely attached to the wall or surface, the mounting plate 280 is properly located or positioned with respect to the light panel 510 after the fixture 100 is removed or detached from the light panel 510.

The process further comprises a step of locating or mounting a bridge piece 232 into slot 514a of the light panel 510, as shown in FIG. 5D. The process further comprises a step of mounting or attaching the light panel body 272 to the mounting plate 280, as shown in FIG. 5E. The step of mounting or attaching the light panel body 272 to the mounting plate 280 also comprises receiving the bridge piece 232 in the slot 274a of the light panel 270. As discussed before, the position of the opening 132 in relation to the aligning side 142 of the fixture 100 is the same as the position of the mounting plate 280 in relation to the sides of the light plate 270. Thus, the side 274 of the light panel body 272 can be properly aligned with the side 514 of the existing light panel 510, as shown in FIG. 5F. The process shown in FIGS. 5A-5F may be similar to the process shown in FIGS. 3A-3F, and detailed description thereof may be omitted.

As shown in FIGS. 3A-3F, 4A-4H, 5A-5F, a single fixture 100 can be used to facilitate locating or mounting of a light panel of a hexagon shape, a diamond shape, or a triangular shape to an existing light panel that is already mounted to a wall or a mounting surface. In one or more embodiments of the present disclosure, the first, second and third openings 112, 122 and 132 are through openings, and thus the mounting plates 220, 250 and 280 can be mounted in a respective opening and then attached to the wall or surface easily and securely, either by adhesive or a fastener. In some circumstances, it is favorable to attach the mounting plate by using a fastener, such as a screw, as such a fastener may achieve a very secure attachment of the mounting plates 220, 250 and 280 to the wall or surface.

In the embodiments shown in the Figures, there are three different shapes of light panels, i.e., a light panel of a hexagon shape, a light panel of a diamond shape and a light panel of a triangular shape. The present disclosure is not limited thereto. In some embodiments of the present disclosure, the light panels may have multiple polygonal shapes, as long as the light panels having multiple polygonal shapes can be assembled to form a lighting product with a desirable shape with a larger area. The fixture may have a corresponding polygonal shape.

In the embodiments shown in the Figures, the fixture 100 has a hexagon shape with six sides. The present disclosure is not limited thereto. In some embodiments of the present disclosure, the fixture 100 may not have a complete hexagon shape. Instead, the fixture 100 may have any suitable shape as long as it has aligning sides and aligning openings properly positioned in relation to the aligning sides.

FIGS. 3A-3F, 4A-4H and 5A-5F show steps of mounting a light panel to an existing light panel by using a fixture 100 according to one or more embodiments of the present disclosure. The present disclosure is not limited thereto. E.g., in some embodiments, the projections 142a, 144a, 146a and the slots 214a, 244a and 274a may be omitted. Accordingly, the steps shown in FIGS. 3D, 4D and 5D may also be omitted.

According to one or more embodiments of the disclosure, the present disclosure can be implemented as follows.

Item 1: A fixture for mounting a plurality of light panels onto a surface, the plurality of light panels having multiple different polygonal shapes that may be assembled to form an assembled light panel having a larger area, each of the plurality of light panels having a light panel body of a polygonal shape and a mounting plate detachably connected to the light panel body,
wherein the fixture comprises one or more aligning sides and a plurality of openings, each opening is sized and shaped to receive a respective mounting plate of a light panel therein, the position of each opening in relation to at least one aligning side of the fixture is the same as or corresponds to the position of the respective mounting plate in relation to at least one side of the light plate to which it is connected.

Item 2: The fixture of Item 1, wherein the fixture comprises a fixture body of a hexagon shape, with a first one of the openings being centered with respect to the fixture body.

Item 3: The fixture of any one of Items 1-2, wherein the fixture body comprises a diamond portion and a triangular portion, with a second one of the openings being centered with respect to the diamond portion and a third one of the openings being centered with respect to the triangular portion.

Item 4: The fixture of any one of Items 1-3, wherein the fixture comprises three aligning sides, with one of the three aligning sides being a side of the triangular portion, and the remaining two aligning sides being two sides of the diamond portion. Item 5: The fixture of any one of Items 1-4, wherein the fixture comprises a projection formed on each aligning side.

Item 6: The fixture of any one of Items 1-5, wherein the plurality of openings are through openings.

Item 7: The fixture of any one of Items 1-6, wherein the plurality of light panels having multiple different polygonal shapes comprises a light panel having a hexagon shape, a light panel having a diamond shape and a light panel having a triangular shape.

Item 8: A method of mounting a plurality of light panels onto a surface by using the fixture of any one of Items 1-7, comprising the steps of:
locating the fixture with respect to an existing light panel that is already mounted to the surface;
locating or matching a mounting plate of a new light panel into an opening of the fixture and attaching the mounting plate to the surface;
removing the fixture from the existing light panel; attaching a light panel body of the new light panel to the mounting plate.

Item 9: The method of Item 8, wherein the step of locating the fixture with respect to an existing light panel comprises aligning one of the aligning sides of the fixture with a side of the existing light panel.

Item 10: The method of any one of Items 8-9, wherein the step of locating the fixture with respect to an existing light panel comprises inserting a projection formed on the one of the aligning sides into a slot in the side of the existing panel.

Item 11: The method of any one of Items 8-10, wherein the step of attaching the mounting plate to the surface comprises attaching the mounting plate to the surface by a fastener.

Item 12: The method of any one of Items 8-11, wherein the step of attaching a light panel body of the new light panel to the mounting plate comprises attaching a light panel body of the new light panel to the mounting plate by a snap connection.

Item 13: The method of any one of Items 8-12, wherein the step of locating or matching a mounting plate of a new light panel into an opening of the fixture comprises locating a mounting plate of a new light panel having a different polygonal shape into a different one of the openings.

Item 14: The method of any one of Items 8-13, wherein the fixture comprises a fixture body of a hexagon shape, with a first one of the openings being centered with respect to the fixture body, the step of locating or matching a mounting plate of a new light panel into an opening of the fixture comprising locating a mounting plate of a new light panel of a hexagon shape in the first one of the openings.

Item 15: The method of any one of Items 8-14, wherein the fixture body comprises a diamond portion and a triangular portion, with a second one of the openings being centered with respect to the diamond portion and a third one of the openings being centered with respect to the triangular portion, and the step of locating or matching a mounting plate of a new light panel into an opening of the fixture comprising locating a mounting plate of a new light panel of a diamond shape in the second one of the openings and/or locating a mounting plate of a new light panel of a triangular shape in the third one of the openings.

Systems and methods have been described in general terms as an aid to understanding details of the disclosure. In some instances, well-known structures, materials, and/or operations have not been specifically shown or described in detail to avoid obscuring aspects of the disclosure. In other instances, specific details have been given in order to provide a thorough understanding of the disclosure. One skilled in the relevant art will recognize that the disclosure may be embodied in other specific forms, for example to adapt to a particular system or apparatus or situation or material or component, without departing from the spirit or essential characteristics thereof. Therefore the disclosures and descriptions herein are intended to be illustrative, but not limiting, of the scope of the disclosure. Accordingly, the disclosure is not to be restricted except in light of the attached claims and their equivalents.

1. A fixture for mounting a plurality of light panels onto a surface, comprising
one or more aligning sides and a plurality of openings, wherein each opening is sized and shaped to receive a respective mounting plate of a light panel therein, a position of each opening in relation to at least one aligning side of the fixture corresponds to a position of the respective mounting plate in relation to at least one side of the light plate to which it is connected; wherein
the plurality of light panels comprise multiple different polygonal shapes that may be assembled to form an assembled light panel having a larger area, each of the plurality of light panels having a light panel body of a polygonal shape and a mounting plate detachably connected to the light panel body.

2. The fixture as claimed in claim 1, wherein the fixture comprises a fixture body of a hexagon shape, with a first one of the openings being centered with respect to the fixture body.

3. The fixture as claimed in claim 2, wherein the fixture body comprises a diamond portion and a triangular portion, with a second one of the openings being centered with respect to the diamond portion and a third one of the openings being centered with respect to the triangular portion.

4. The fixture as claimed in claim 3, wherein the fixture comprises three aligning sides, with one of the three aligning sides being a side of the triangular portion, and a remaining two aligning sides being two sides of the diamond portion.

5. The fixture as claimed in claim 1, wherein the fixture comprises a projection formed on each aligning side.

6. The fixture as claimed in claim 1, wherein the plurality of openings are through openings.

7. The fixture as claimed in claim 1, wherein the plurality of light panels having multiple different polygonal shapes comprises a light panel having a hexagon shape, having a diamond shape and a light panel having a triangular shape.

8. A method of mounting a plurality of light panels onto a surface by using a fixture, the method comprising the steps of:
locating the fixture with respect to an existing light panel that is already mounted to the surface;
locating or matching a mounting plate of a new light panel into an opening of the fixture and attaching the mounting plate to the surface;
removing the fixture from the existing light panel;
attaching a light panel body of the new light panel to the mounting plate.

9. The method as claimed in claim 8, wherein the step of locating the fixture with respect to the existing light panel comprises aligning one of the aligning sides of the fixture with a side of the existing light panel.

10. The method as claimed in claim 8, wherein the step of locating the fixture with respect to the existing light panel comprises inserting a projection formed on the one of the aligning sides into a slot in the side of the existing light panel.

11. The method as claimed in claim 8, wherein the step of attaching the mounting plate to the surface comprises attaching the mounting plate to the surface by a fastener.

12. The method as claimed in claim 8, wherein the step of attaching the light panel body of the new light panel to the mounting plate comprises attaching the light panel body of the new light panel to the mounting plate by a snap connection.

13. The method as claimed in claim 8, wherein the step of locating or matching the mounting plate of a new light panel into the opening of the fixture comprises locating a mounting plate of a second new light panel having a different polygonal shape into a different one opening.

14. The method as claimed in claim 8, wherein the fixture comprises a fixture body of a hexagon shape, with the opening being centered with respect to the fixture body, the step of locating or matching a mounting plate of the new light panel into the opening of the fixture comprising locating the mounting plate of the new light panel of a hexagon shape in the opening.

15. The method as claimed in claim 14, wherein the fixture body comprises a diamond portion and a triangular portion, with a second opening being centered with respect to the diamond portion and a third opening being centered with respect to the triangular portion, and the step of locating or matching the mounting plate of the new light panel into the opening of the fixture comprising locating a mounting plate of a new light panel of a diamond shape in the second opening and/or locating a mounting plate of a new light panel of a triangular shape in the third opening.

16. The method as claimed in claim 8, wherein the fixture comprises one or more aligning sides and a plurality of openings, wherein each opening is sized and shaped to receive a respective mounting plate of a light panel therein, a position of each opening in relation to at least one aligning side of the fixture corresponds to the position of the respective mounting plate in relation to at least one side of the light plate to which it is connected.

17. The method as claimed in claim 16, wherein the plurality of light panels comprise multiple different polygonal shapes that may be assembled to form an assembled light panel having a larger area, each of the plurality of light panels having a light panel body of a polygonal shape and a mounting plate detachably connected to the light panel body.

18. The method as claimed in claim 8, wherein the fixture comprises a fixture body of a hexagon shape, with then opening being centered with respect to the fixture body.

19. The method as claimed in claim 8, wherein the fixture comprises a projection formed on each aligning side.

20. The method as claimed in claim 8, wherein the opening is a through opening.
